(19) United States
(12) Patent Application Publication
(10) Pub. No.: US 2003/0224532 A1
(43) Pub. Date: Dec. 4, 2003

(54) Apparatus and method for synthesis and transfer of sensitive compounds

(75) Inventors: Michael E. Smith, Downington, PA (US); John Stuligross, Downington, PA (US)

Correspondence Address: FOLEY AND LARDNER, SUITE 500, 3000 K STREET NW, WASHINGTON, DC, 20007, US

(73) Assignee: hte AG

(21) Appl. No.: 10/159,270

(22) Filed: Jun. 3, 2002

(51) Int. Cl. B01J 19/00

(52) U.S. Cl. 436/180; 422/99; 422/130

(57) ABSTRACT

An apparatus and method is provided for synthesizing and transferring substances which are air-sensitive and/or moisture-sensitive and/or light-sensitive. The apparatus comprises at least three automatic valves, at least one primary pump, at least one manifold comprising at least two means for receiving said substances and at least one tubing system.

### CROSS-REFERENCE TO RELATED PATENT APPLICATIONS

### BACKGROUND OF THE INVENTION

The present invention relates to an apparatus and a method for synthesizing and transferring substances which are air-sensitive and/or moisture-sensitive and/or light-sensitive.

In more detail, the present invention describes an apparatus and method for synthesis and transfer of air-, moisture- and/or light-sensitive substances in an automatic, rapid serial fashion without additional environmental control. The absence of additional environmental control (i.e. purge or glove box) is desirable to minimize the cost and improve the ease of installation, operation, and maintenance.

Specifically, this invention allows sequential loading of one or more substances into one or more sample loops from one or more means for receiving substances, particularly vials. Each loading can then be charged to any of the means for receiving substances connected to a manifold or to any of the reactors, preferably at reaction conditions.

Test methods are known to date in which the test reactor is provided within the synthesis chamber, in which case the air-sensitive substances, on transfer from the synthesis chamber into the test reactor, do not leave the protective gas atmosphere. The substances are activated while they are still in the synthesis chamber. However, these methods have the disadvantage that, in particular, substances which after their activation are only stable to a limited extent and thus cannot be exposed to relatively long storage, must be transferred immediately to the test reactor, in order to achieve useable test results. In addition, there is the problem here that only a limited amount of substances can be prepared and activated, that is to say only as much as can also be tested in the test reactor (U.S. Pat. No. 6,030,917).

Also known are pressurized sealable transportable container from EP 0582016 B and a chemical sampling or dispensing apparatus from EP 0894257 B for handling sensitive substances.

Furthermore, a process and an apparatus for transferring air-sensitive substances is known which enables the air-sensitive substances to be transferred from a synthesis site to a test reactor without the presence of a protective gas atmosphere and not to be activated until in the test reactor (U.S. Ser. No. 09/997,285).

So it was an object underlying the present invention to provide an apparatus for synthesizing and transferring substances which are air-sensitive and/or moisture-sensitive and/or light-sensitive which allows delivery of the sensitive compounds to vessels at elevated or reduced pressure and at elevated or reduced temperature without manual intervention and without the use of any robotic dispensers or other “x, y” translation equipment and further to minimize the cost and improve the ease of installation, operation, and maintenance.

### SUMMARY OF THE INVENTION

In accomplishing the foregoing and other objects of the invention, there has been provided, according to one aspect of the invention, an apparatus for synthesizing and transferring substances which are air-sensitive and/or moisture-sensitive and/or light-sensitive. The apparatus comprises at least three automatic valves, at least one primary pump, at least one manifold comprising at least two means for receiving substances and at least one tubing system.

A further aspect of the invention provides for a process for synthesizing and transferring substances which are air-sensitive and/or moisture-sensitive and/or light-sensitive, within said apparatus comprising charging at least one third substance from a sample loop to at least one reactor at reaction conditions and sampling at least one third substance.

In addition, the present invention relates to a computer program having program code means for carrying out the inventive process, and for controlling and/or regulating the inventive apparatus, and to a data carrier comprising the computer program.

The program code means preferably comprise sections of program code that can execute one or more of the process steps in an automated fashion. The sections may be combined and repeated in any order, providing great flexibility in using the equipment.

Some terms used in the context of the present application may be clarified at this point:

At Reaction Conditions: For the purpose of this application, “at reaction conditions” refers to conditions that significantly exceed atmospheric pressure (greater than 1 atmosphere gauge or 15 psig [pounds per square inch gauge]) and are greater than or less than ambient temperature (typically taken as 20° C.).

Line(s): For the purpose of this application, “line” refers to hollow tubing, sometimes but not necessarily of known volume, with (preferred non-ferrule) fittings on both ends that is intended to be replaced primarily for maintenance purposes. The line may be manufactured from metals, glass, plastics such as polyolefins such as, for example, PE, PP and their copolymers with higher olefins, PVC, ceramics and composite materials of the above mentioned materials. Furthermore, the line materials will be opaque to light when used with light-sensitive substances.

Manifold: For the purpose of this application, a “manifold” comprises at least one integral block with means for receiving said at least two means for receiving substances, at least one fluid supply system and preferably means for supporting the manifold.

Pump(s): For the purpose of this application, “pump” refers to a device that delivers a fluid at a known rate at a given pressure. Typical examples are pumps of a HPLC, syringe, etc.

Reactor(s): For the purpose of this application, “reactor” refers to an individual vessel that is capable to be pressurized in significant excess of atmospheric pressure (greater than 1 atmosphere gauge or 15 psig). The reactor will have one or more ports for at least one of the following purposes: introduction of substances, in-situ measurement devices (i.e. thermocouple), reactor contents agitation, and other apparatuses typically known to those versed in the art.

Sample loop(s): For the purpose of this application, “sample loop” refers to a length of tubing of an accurately known volume with (preferred non-ferrule) fittings on both ends that is intended to be replaced on a regular basis to accommodate changes in experimental parameters. The sample loop may be manufactured from metal, glass, plastics such as polyolefins such as, for example, PE, PP and their copolymers with higher olefins, PVC, ceramics and composite materials of the above mentioned materials. Furthermore, the sample loop materials will be opaque to light when used with light-sensitive substances.

Selector valve(s): For the purpose of this application, “selector valve” refers to a valve that selects between two or more positions that alter the flow path(s) of a fluid. The selector valve can be manually or automatically controlled, and actuated manually, electronically, pneumatically, or by any other known method.

Substance(s): Such substances which can be transferred by the apparatus and process according to the present invention comprise air-sensitive and/or moisture-sensitive and/or light-sensitive substances of organic, inorganic and biological nature and/or origin. Examples which may be mentioned include, for example, substances which are suitable as catalysts, moderators and activators, enzymes, peptides, polypeptides, cells and other biological systems. Preferably, the apparatus and process is suitable for transferring air-sensitive substances selected from homogeneous catalysts such as, for example, organometallics, and activators such as, for example, methylaluminoxanes, Al-alkyl compounds and boron fluorides, such as, for example, those described in EP-A 0 277 004, an article by Bonini et al. in J. Polym. Sci, 33, 2393-2402 (1995), and Chemical Reviews “Frontiers in metal-catalyzed polymerization”, April 2000, Vol 100, No. 4, all expressly incorporated by reference in their entities, and heterogeneous catalysts, such as, for example, metallic catalysts without passivation and pseudo-organometallic catalysts. Particularly preferably, the process is suitable for transferring the following air-sensitive substances: metallocenes and postmetallocenes. Such post metallocenes can be based on LTM (late transition metal) or ETM (early transition metal). Furthermore, “substance” generally refers to any fluid that can be delivered via connections fabricated preferably from hollow tubing. The substance can be a pure liquid or a liquid solution, a gas, a dispersion, a emulsion, etc. of one or more other chemical species or a fluid suspension of particles in a liquid medium. A non-exhaustive list of categories of substances includes solvents, activators, catalysts, moderators, and initiators.

Tubing system: For the purpose of this application, “tubing system” comprises all lines and fittings that connect the manifold, selector valves, reactors, pumps and sample loops.

Means for receiving substances: For the purpose of this application, “means for receiving substances” refers to any individual container that can be affixed in a gas-tight manner to a manifold with a matching connector. The container can be of any volume and dimensions that allow the container to be connected adjacent to a second container already connected to said manifold. Examples include, but are not limited to, vials, screw-top threaded vials, flasks or other containers with ground glass tapered joints, crimp top vials, and custom manufactured containers with quarter-turn fasteners with bayonet catch. The means for receiving substances may be manufactured from glass, metal, plastics such as polyolefins such as, for example, PE, PP and their copolymers with higher olefins, PVC, ceramics and composite materials of the above mentioned materials. Furthermore, the materials of the means for receiving substances will be opaque to light when used with light-sensitive substances. Means for receiving substances specifically do NOT refer to a single chamber or well in a multi-chamber or multi-well device, e.g. an 8×12 microtiter plate. Within the present application the term “means for receiving substances” is often denoted as “vial” for simplicity reasons, but not meant to limit the scope of the disclosure to “vial”, which is one embodiment of said means.

According to the invention the minimal case of 3 valves comprises: one valve to select from the series of vials; one valve to select from the series of sample loops; and one valve to select from the series of reactors. The fourth additional valve is preferred for selection of the fluid source and adds the capability of delivering fluids from the sample loops into the vials. All of these valves can be automatic valves, which may consist of individual selector valves (e.g. multi-port valves) or a plurality of single valves.

Further according to the invention the primary pump is preferably a high pressure liquid pump. Also possible is use of a HPLC (high pressure liquid chromatography). Other examples for high pressure liquid and fluid pumps respectively, useable in the present invention are peristaltic pumps, reciprocating pumps (piston pumps) or centrifugal pumps (rotatory pumps), membrane pumps, syringe pumps and pneumatic driven pumps. The required primary pump provides the driving force for delivering fluids to both the vials and the reactors preferably at reaction conditions. The pressure of the inert gas in the vial manifold provides the driving force for dispensing from the vials to the sample loops.

High pressure means in the scale of the invention preferred a pressure in the range of 2 to 200 bar (29 to 2900 psig) more preferred a pressure range of 5 to 100 bar (72.5 to 1450 psig) and especially a pressure higher than 34.5 bar (500 psig).

According to the invention the manifold comprises at least one integral block with means for receiving vials, at least one fluid supply system and means for supporting the manifold.

The integral block can be made from any suitable material like metal, synthetic material (e.g. plastics such as polyolefins such as, for example, PE, PP and their copolymers with higher olefins, PVC), ceramic, glass, fibre glass and composite materials of the above mentioned materials.

Furthermore, the means for receiving vials comprise at least one opening, in which the opening is fitted to allow a vial to be fixed snugly into the opening.

In one embodiment, the opening is threaded to allow a vial to be screwed snugly into the opening. The opening can also be shaped for a positive locking between vial and integral block. Non-positive connections, for example, actuated by spring and/or adherence are conceivable as well. A quarter-turn fastener and bayonet catch respectively is another example for a possible connection between vial and integral block.

The geometrical shape of the opening is unconstrained except that it matches the shape of the connection of the vial. Especially for plug-type connections the opening shape can also be polygonal e.g. square or triangular. Also not limited is the number of openings per manifold.

The vials (e.g. vessels) are for receiving the sensitive substances and compounds. Therefore the vial material should be inert with respect to the substances or components present therein such as, for example an organometallic catalyst, an activator, a moderator, reactants and possibly, other reagents, such as reaction inhibitors which may be added later, for example water or alcohol. This is necessary in order to prevent unwanted decomposition of the sensitive substances. Suitable vessel materials include preferably glass, plastics such as polyolefins such as, for example, PE, PP and their copolymers with higher olefins, PVC, metals, ceramics and composite materials of the above mentioned materials. Furthermore, the vessel materials will be opaque to light when used with light-sensitive substances.

Particular preference is given to glass, ceramics and composite materials made of glass, ceramics and plastic, and to tinted materials or materials having special light-protecting layers.

Typically, the vials are sealed against the integral block. Preferred seal materials are curable or viscous materials such as resins, polymers, waxes, amalgams, curable polymers or perfluorinated oils and waxes. These materials can for example be provided as a ring into a sealing groove.

Particularly preferably the sealing is performed using the curable or viscous materials as just described above.

These materials should also interact as little as possible with substances or components.

According to the present invention it is further possible that the vials can be agitated by any number of methods, including but not limited to magnetic stirring, mechanical stirring, and vortex stirring.

The vials can have means for agitation, in which these means for agitation can comprise one or more intrusive device (e.g. a stir-bar) and/or one or more non-intrusive device (e.g. a vortex shaker).

Further, according to the present invention each opening comprises means to make at least two additional connections. These additional connections comprise at least one common gas supply preferentially for supplying inert gas and at least one single open-ended tube for each vial both as part of the fluid supply system. The fluid supply system is preferably a system of single flexible or solid tubes, which could be connected to one another, so that for each vial a closed supply line is formed by these tubes from the selector valve on the one end to the vial with the single open-ended tube on the other end.

Such a system of flexible or solid tubes are also provided between the selector valves and between the one or more pumps and the selector valves as part of the tubing system.

Furthermore, the common gas supply can comprise paths machined in the manifold and/or separate lines for each vial.

The term “path” describes a connection running through the integral block between two openings present on the body surface, which connection permits, for example, the passage of a fluid through the body. The path can have any desired geometry in this case. It can have a cross-sectional area which is variable over the length of the path or it can preferably have a constant path cross-sectional area. The path cross section can have, for example, an oval, round or polygonal periphery having straight or curved connections between the points of the polygon. Preference is given to a round or equilateral polygonal cross section. Preferably, all paths in the integral block have the same geometry (cross section and length).

Each of the single open-ended tubes is connected on one end preferably to a selector valve and each of the single open-ended tubes protrude below the manifold to allow removal of the vial contents via the tubes.

Furthermore, each of the single open-ended tubes may be connected with an adjustable mechanism, for example, adjustable fittings to alter the depth the tubes protrude into the vials. Because of that it is possible to place each of said single open-ended tubes at a depth that allows free movement (e.g. rotation) of an internal agitation device (i.e. a magnetic stir bar) placed in the bottom of the vial. Furthermore, the adjustable depth of the tubes allows for optimal use of vials of different heights that use a common connection design.

Furthermore according to the present invention the means for supporting the manifold comprise at least one supporting rod that allows, for example, clamping of the manifold to a rigid, preferably vertical support to ensure stable operation.

Instead of one or more supporting rods any means known to the person skilled in the art suitable for fastening and supporting the manifold are also thinkable.

According to the present invention the apparatus can optionally further comprise at least one syringe pump or other secondary pump. The secondary pump would be used to provide additional suction for dispensing viscous fluids from the vials. There is no limitation on the type of pump used for either position.

Further according to the present invention the apparatus comprises at least one sample loop. The volumes of the sample loops can be varied independently and used for storage or intermediate storage of defined amounts of activator, solvent (e.g. dry solvent) or nitrogen and the sensitive substance in liquid or solution form.

Both selector valves and sample loops could be parts usual in commerce.

The tubes of the tubing system could be flexible or solid tubes. They are the protective means for transferring the sensitive substances from the respective vials to the corresponding reactors.

The tubing material should be inert with respect to the substances or compounds present therein such as, for example an organometallic catalyst, an activator, a moderator, reactants and possibly, other reagents, such as reaction inhibitors which may be added later, for example water or alcohol. This is necessary in order to prevent unwanted decomposition of the air-sensitive substances. Suitable tubing materials include preferably glass, plastics such as polyolefins such as, for example, PE, PP and their copolymers with higher olefins, PVC, metals, ceramics and composite materials of the above mentioned materials.

Concerning the tubing materials, particular preference is given to metals, chemically resistant plastics (e.g. Teflon, PEEK—Polyetheretherketone), and to tinted materials or materials having special light-protecting layers.

Furthermore, at least one computer system can be a part of the apparatus preferential to control the adjustments of the ports (positions) of the selector valves and the operation of the one or more pumps.

The process according to the present invention can further comprise:

(a) load at least one first substance to at least one means for receiving substances;

(b) load at least one second substance to at least one sample loop;

(c) charge said at least one second substance to said at least one means for receiving substances;

(d) mixing said at least one first substance with said at least one second substance in said at least one means for receiving substances to receive a third substance; and

(e) backflush the contents of any or all lines with at least one cleaning solvent.

Preferred, the backflush takes place to the vial containing the sample prior to sampling the next activated substance.

Furthermore, the process according to the present invention can further comprise pretreatment of at least one reactor with at least one activator, treatment of at least one substance in at least one means for receiving substances with at least one activator and deliver at least one activated substance to at least one reactor at reaction conditions, i.e. elevated pressure and elevated or reduced temperature.

Preferably, the activator is flushed into the reactor with at least one dry solvent during the pretreating step.

Further objects, features and advantages of the present invention will become apparent from the detailed description of preferred embodiments that follows when considered together with the accompanying drawings.

For a better understanding the following the “substances” are divided in “first substances” (e.g. potential catalysts), “second substances” for treating the “first substances” (e.g. activator or moderator) and substances after mixing and treatment respectively so called “third substances” (e.g. activated catalysts).

### BRIEF DESCRIPTION OF THE DRAWINGS

The present invention is described in detail below with reference to one exemplary embodiment, which is only one example, not a defining example, and with reference to the accompanying drawings in which:

FIG. 1 shows a diagrammatic representation of adjustments of the selector valves of the apparatus during the step “Load Second Substance in Sample Loop 18”;

FIG. 2 shows a diagrammatic representation of adjustments of the selector valves of the apparatus during the step “Charge Second Substance from Sample Loop 18 to Reactors”;

FIG. 3 shows a diagrammatic representation of adjustments of the selector valves of the apparatus during the step “Load Second Substance to Sample Loops 20 and 22”;

FIG. 4 shows a diagrammatic representation of adjustments of the selector valves of the apparatus during the step “Charge Second Substance from Sample Loops 20 and 22 to vials”;

FIG. 5 shows a diagrammatic representation of adjustments of the selector valves of the apparatus during the step “Load Third Substance to Sample Loop 20”;

FIG. 6 shows a diagrammatic representation of adjustments of the selector valves of the apparatus during the step “Charge Third Substance from Sample Loop 20 to Reactors”;

FIG. 7 shows a diagrammatic representation of adjustments of the selector valves of the apparatus during the step “Backflush Sample Loop 22 to vial”;

FIG. 8 shows a diagrammatic representation of the vial manifold; and

FIG. 9 shows a diagrammatic representation of an apparatus arrangement with only three selector valves.

### DETAILED DESCRIPTION OF THE PREFERRED EMBODIMENTS

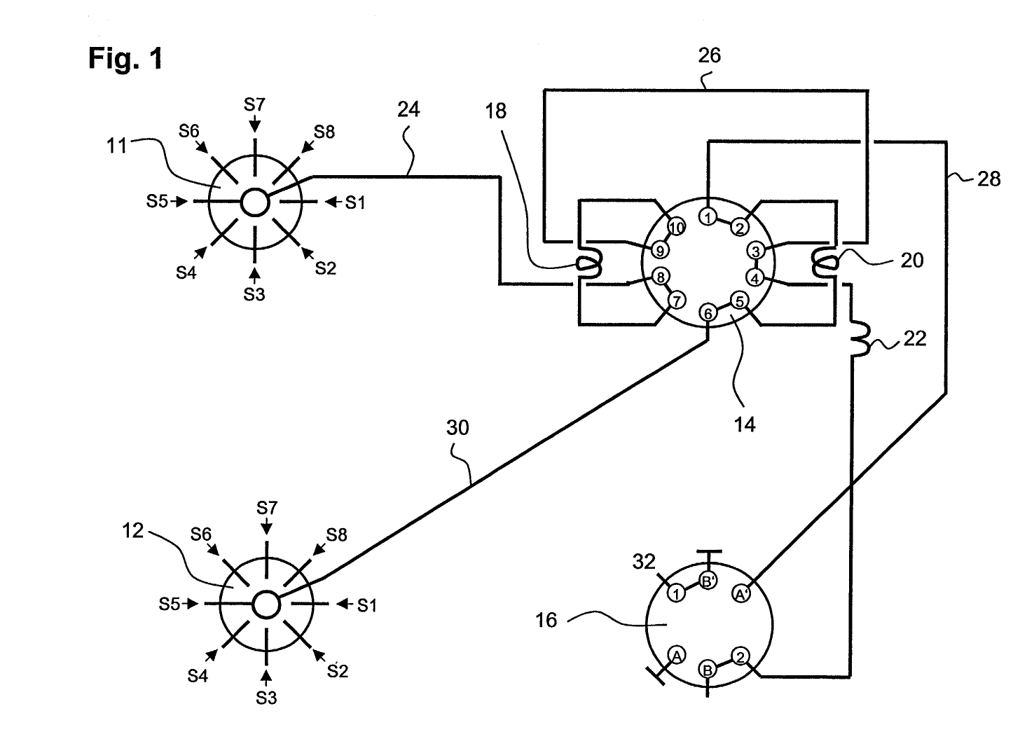

The apparatus shown in FIG. 1 comprises four selector valves 11, 12, 14, 16, in which reference number 11 denotes a “vial selector valve” and reference number 12 denotes a “reactor selector valve”. Both selector valve 11 and 12 are eleven-port, ten-position valves. Reference number 14 denotes a “sample loop selector valve”, which is a ten-port, two-position valve. Reference number 16 denotes a “fluid source selector valve”, which is a six-port, two-position with bypass valve.

Each port, one to ten of the “vial selector valve” 11 is connected to a corresponding vial of the vial manifold, in which vial one to eight is provided for receiving at least one first sensitive substance or compound (e.g. catalyst) and vial nine is provided preferably for receiving at least one second sensitive substance (e.g. activator or moderator). Vial ten is usual empty and is used when a clean nitrogen flow, free of solvent, is needed directly from the common supply of the manifold. Port eleven is the common point through which the selected position's solution travels. It connects the valve to the rest of the tubing system. The vial manifold is not shown in FIG. 1.

Each port, one to eight of the “reactor selector valve” 12 is connected to a corresponding reactor of the reactor manifold, in which reactor one to eight is provided for receiving at least one first sensitive substance or compound, preferred catalysts at reaction conditions. The “reactor selector valve” 12 is identical to “vial selector valve” 11. Ports nine and ten are not used in the example. Port eleven is as described above. The reactor manifold is also not shown in FIG. 1.

Another part of the apparatus shown in FIG. 1 are three sample loops 18, 20, 22 preferred with different volumes. Sample loop 18 for example has a volume of 60 μL (microlitre), sample loop 20 for example has a volume of 200 μL and sample loop 22 for example has a volume of 500 μL. The volumes of the sample loops can be varied.

Stainless steel and PEEK are the preferred materials for the sample loops. They should factory-cut and finished to the highest quality. The stainless steel sample loop ends have a square cut and are burr-free for a flush connection to the valve. The flexible PEEK sample loop ends are provided with a clean and straight cut for easy installation onto the valve. Stainless steel (and titanium) sample loops are supplied with unswaged fittings. The two ends of the sample loop must be completely bottomed in the injector ports before the ferrule is swaged onto the sample loop. Swaging each end separately and then replacing the ends in their respective ports of the same valve ensure that the sample loop ends are bottomed into the ports. A fitting made up in one port may leave an undesirable cavity in another port. As all ports vary in all valves, careful attention to sample loop installation is important.

PEEK sample loops can also supplied with unswaged RheFlex® Fittings but do not require the same swaging precaution. The fittings can reposition along the sample loop lines when the fitting reinserts in the ports for correct sample loop installation.

PEEK lines can be used instead of stainless steel lines in most applications, because PEEK is inert to almost all organic solvents and is biocompatible.

The lines 24, 26, 28 and 30 also shown in FIG. 1 are parts of the tubing system. The material used for these lines can also be stainless steel or PEEK.

Preferential, stainless steel is used as material for the sample loops and lines.

At least one fluid source preferably a primary pump (e.g. liquid pump) 32 is connected to port 1 of the “fluid source selector valve” 16. The port B on the “fluid source selector valve” 16 can alternatively or additionally be connected to a syringe pump or other secondary pump (not shown in FIG. 1) particularly to ensure re-producible transfer of more viscous media (e.g. solutions).

The “fluid source selector valve” 16 comprises three adjustable positions. In Position 1, port 1 is connected to port A′ and port A is connected to port 2. Ports B and B′ are closed. In Position 2, port 1 is connected to port 2. Ports A, A′, B and B′ are closed. In Position 3, port 1 is connected to port B′ and port B is connected to port 2. Ports A and A′ are closed.

The ten port “sample loop selector valve” 14 comprises preferentially two adjustable positions. In Position 1, port 2 is connected to port 3, port 4 is connected to port 5, port 6 is connected to port 7, port 8 is connected to port 9 and port 10 is connected to port 1. In Position 2, port 1 is connected to port 2, port 3 is connected to port 4, port 5 is connected to port 6, port 7 is connected to port 8 and port 9 is connected to port 10.

The connections of the separate lines 24, 26, 28, 30 and the separate sample loops 18, 20, 22 to the separate selector valves 11, 12, 14 and 16 are clear shown in FIG. 1 and are not described more detailed hereinafter.

The apparatus as shown in the example (FIG. 1) handles 8 first sensitive substances or compounds per pass, but the design allows convenient expansion to a much higher multiplicity of compounds.

One significant advantage is the fact that all source (vials) and receiving (reactors) vessels remain in place. No use of any robotic dispensers or other “x, y” translation equipment is necessary.

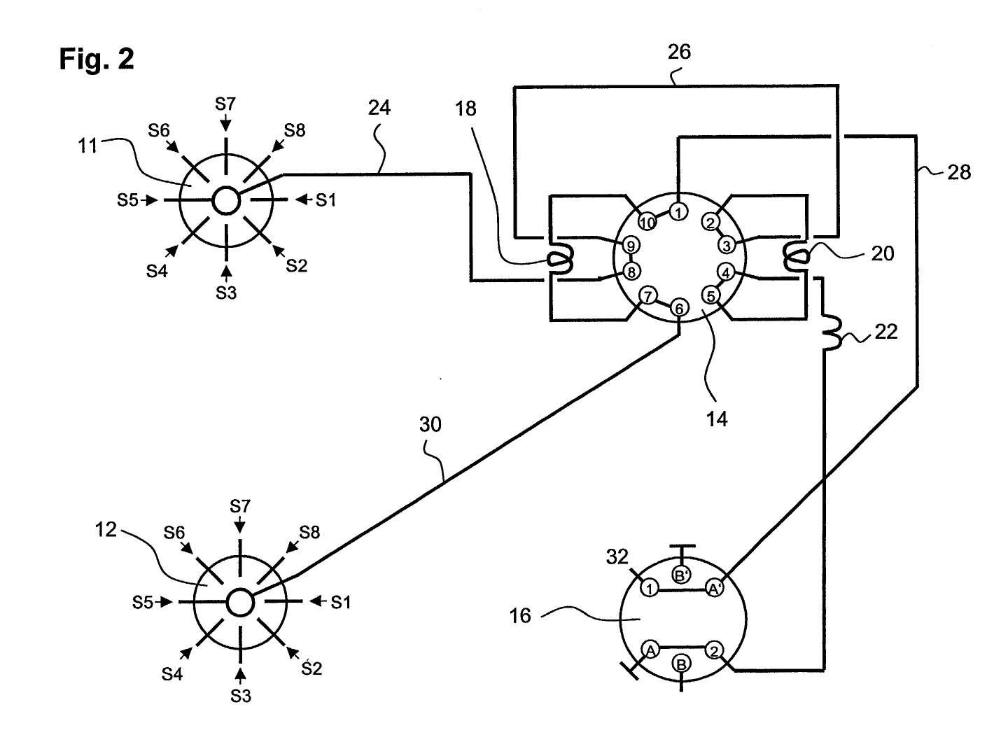

All explanations made to FIG. 1 up to here are also applicable to the following FIGS. 2 to 7.

During the step I “Load Second Substance in Sample Loop 18” shown in FIG. 1, port 9 of the “vial selector valve” 11, which is switched “open” to-vial 9 of the vial manifold, is connected to one end of line 24, which is connected on the other end to port 8 of the “sample loop selector valve” 14. All other ports of the “vial selector valve” 11 are closed.

The “sample loop selector valve” 14 is switched to Position 2. In this Position 2 port 8 is connected to port 7. Port 7 is connected to one end of the 60 μL sample loop 18. The other end of the 60 μL sample loop 18 is connected to port 10. Port 10 is in Position 2 connected to port 9. Port 9 is connected to one end of line 26. The other end of line 26 is connected to port 3, which is connected to port 4. Port 4 is connected to one end of the 500 μL sample loop 22. The other end of the 500 μL sample loop 22 is connected to port 2 of the “fluid source selector valve” 16, which is switched to Position 3. In Position 3, port 2 of the “fluid source selector valve” 16 is connected to port B. Port B is switched open and can be connected to a secondary pump, for example, a syringe pump or an other liquid pump (not shown in FIG. 1). So a closed line is build for loading a second substance (e.g. activator) from vial 9 of the vial manifold to the 60 μL sample loop 18. If the 60 μL sample loop 18 is completely filled with the second substance (e.g. activator) the loading operation is stopped.

The other connection from the “reactor selector valve” 12 through line 30 to the “sample loop selector valve” 14, through the 200 μL sample loop 20 and through line 28 to port A′ of the “fluid source selector valve” 16 is during step I turned off.

The next step II “Charge Second Substance from Sample Loop 18 to Reactors” shown in FIG. 2 is following. In this step the “fluid source selector valve” 16 is switched to Position 1 and the “sample loop selector valve” 14 is also switched to Position 1. In this Position 1 port 1 of the “fluid source selector valve” 16 is connected to port A′. Port A′ is connected to one end of line 28. The other end of line 28 is connected to port 1 of the “sample loop selector valve” 14, which is also connected to port 10. Port 10 and port 7 of the “sample loop selector valve” 14 connects the 60 μL sample loop 18. Port 7 and port 6 are also connected to another and line 30 connects port 6 of the “sample loop selector valve” 14 to the “reactor selector valve” 12. The port of the “reactor selector valve” 12 connected to line 30 is switched to reactor 1 of the reactor manifold.

By turning “On” the primary pump 32 connected to port 1 of the “fluid source selector valve” 16 the second substance (e.g. activator) stored in the 60 μL sample loop 18 is flushed into the reactor 1 with dry solvent. This procedure (step I and step II) is repeated for each of the eight reactors placed in the reactor manifold for pretreating each reactor with a small amount (60 μL) of the second substance (e.g. activator) to eliminate trace amounts of moisture and oxygen in the reactors.

The other connection from “vial selector valve” 11 over “sample loop selector valve” 14 to port 2 of the “fluid source selector valve” 16 is during step II turned “Off”.

Examples for suitable dry solvents are any organic liquid that has been chemically treated to remove trace water i.e. hexane treated with sodium benzophenone ketyl; ethanol distilled from calcium hydride under nitrogen atmosphere. An exhaustive list can be found in several references, including “Purification of Laboratory Chemicals” by Armarego, W. L. F. and Perrin, D. D., 4th Edition, Reed Educational Publishing, Ltd., Oxford, 1996 and “The Manipulation of Air-Sensitive Compounds” by Shriver, D. F. and Drezdzon, M. A., 2nd Edition, John Wiley & Sons, NYC, 1986.

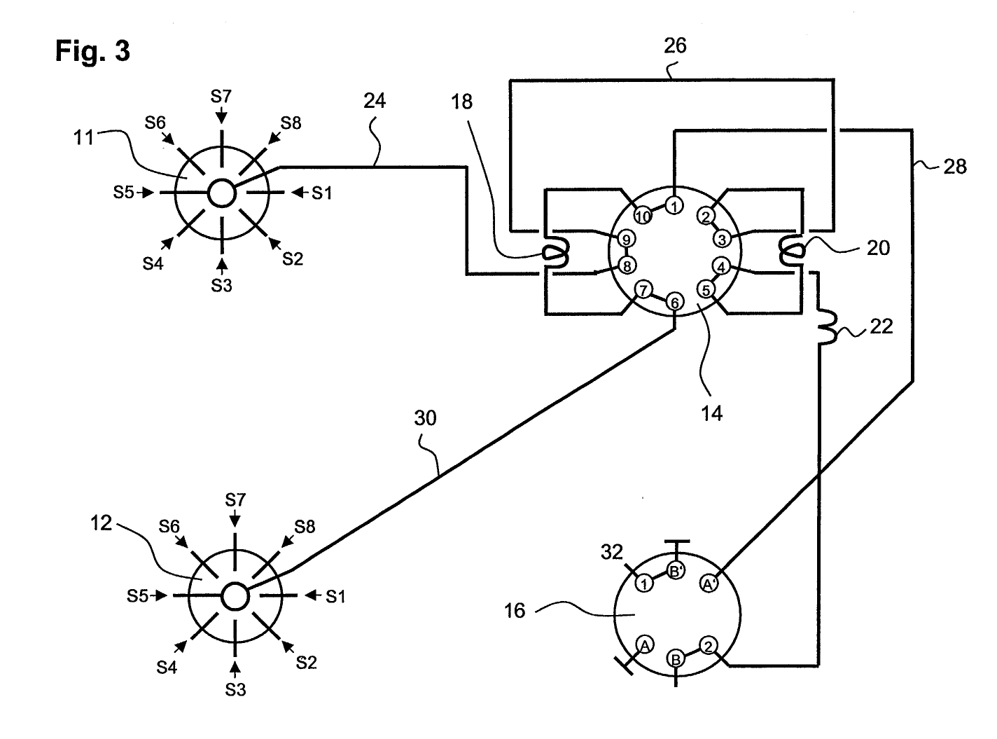

Step II is followed by step III “Load Second Substance to Sample Loops 20 and 22” shown in FIG. 3. In this step “sample loop selector valve” 14 is set to Position 1 and the “fluid source selector valve” 16 is set to Position 3. The switching in step III is similar to step I. Only the “sample loop selector valve” 14 is set to Position 1 in contrast to step I. This switching of the “vial selector valve” 11, the “sample loop selector valve” 14 and the “fluid source selector valve” 16 makes it possible to load the second substance (e.g. activator) from vial 9 of the vial manifold over “vial selector valve” 11, trough lines 24 and 26 to the 200 μL sample loop 20. If the 200 μL sample loop 20 and the 500 μL sample loop 22 is completely filled with the second substance (e.g. activator) the loading operation is stopped.

The other connection from “reactor selector valve” 12 over “sample loop selector valve” 14 to port A′ of the “fluid source selector valve” 16 is during step III turned “Off”.

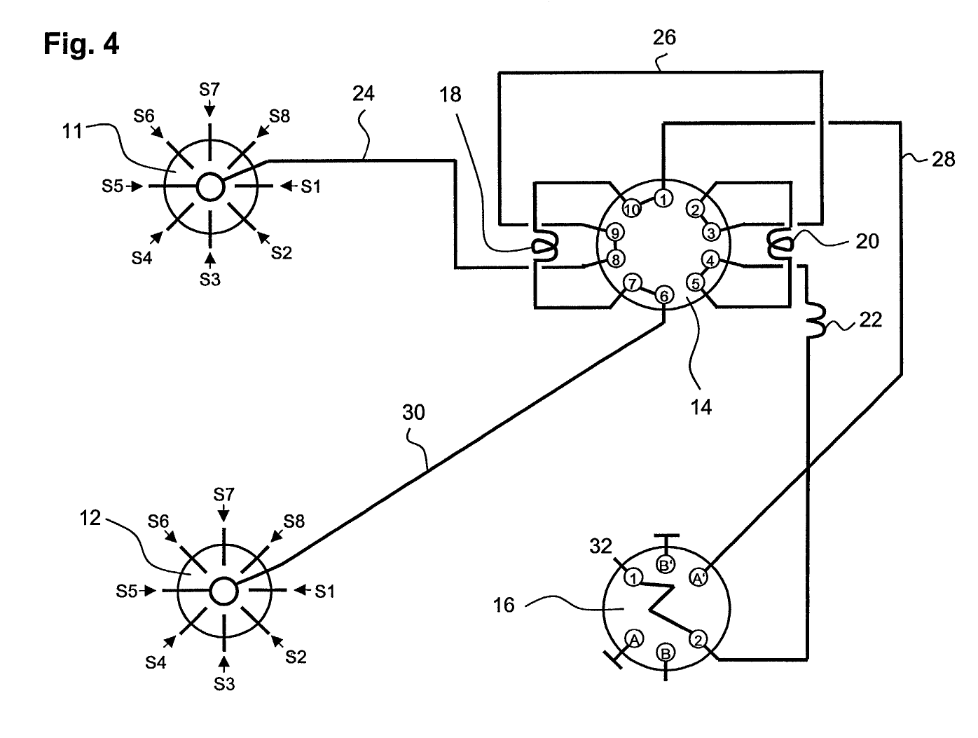

The next step IV “Charge Second Substance from Sample Loops 20 and 22 to Vials” shown in FIG. 4 is following. In this step the “fluid source selector valve” 16 is switched over to Position 2 and the setting of “sample loop selector valve” 14 is kept to Position 1. In addition “vial selector valve” 11 is turned from vial 9 to vial 1 of the vial manifold, so that the line 24 is now connected to vial 1.

Now, the first sensitive substance or compound (e.g. catalyst) in vial 1, preferred loaded to the vial before, is treated with a larger amount (200 μL+the volume of the 500 μL sample loop 20 and lines 24 and 26, typically 600 μL=800 μL in sum) of the second substance (e.g. activator). This procedure (step III and step IV) is repeated for each of the eight vials placed in the vial manifold for treating each first sensitive substance or compound in vial with one or more second substances, for example, activator. After mixing the first substance with the second substance (i.e. during activation) the activated substance is denoted as third substance.

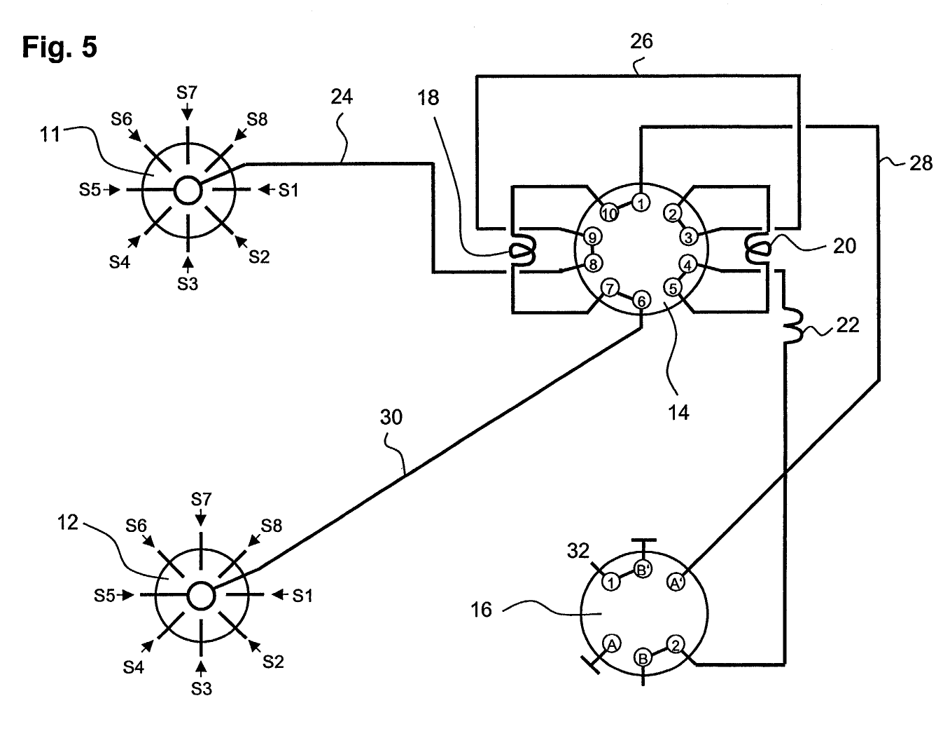

After a pre-defined mixing (treatment) time, preferred 200 μL of the third (activated) substance or compound (e.g. catalyst) is loaded from vial 1 to the 200 μL sample loop 20 in step V “Load Third Substance to Sample Loop 20” shown in FIG. 5.

In step V Position 1 of “sample loop selector valve” 14 is kept and the “fluid source selector valve” 16 is switched over to Position 3. If the 200 μL sample loop 20 is completely filled with the third substance (e.g. activated catalyst) the loading operation is stopped.

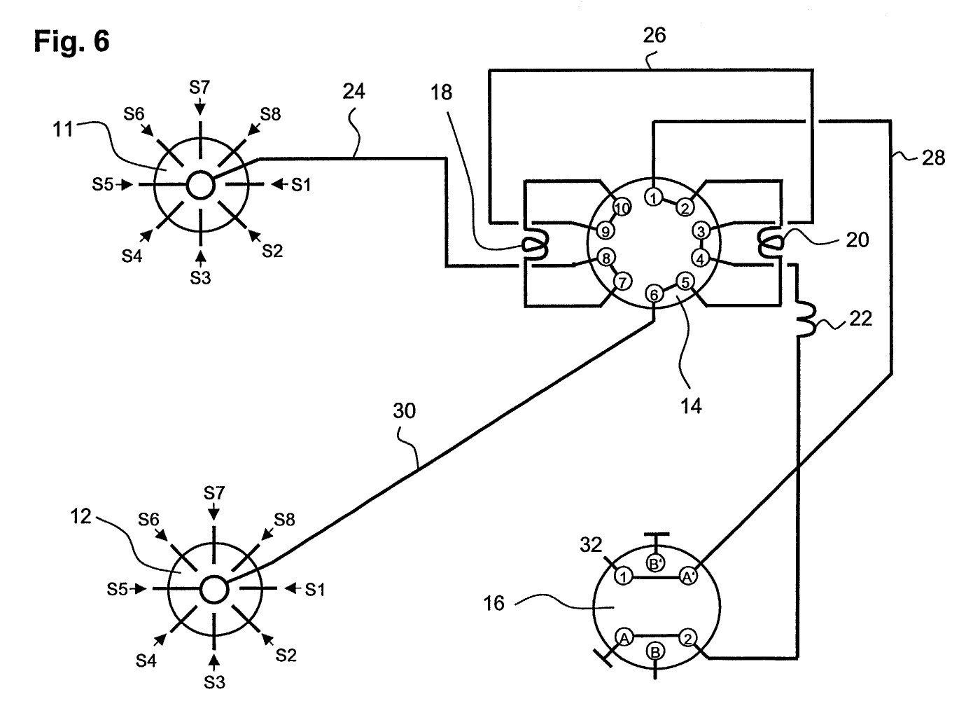

The next step VI “Charge Third Substance from Sample Loop 20 to Reactors” shown in FIG. 6 is following. In this step the “fluid source selector valve” 16 is switched over to Position 1 and the “sample loop selector valve” 14 is switched to Position 2. In addition “reactor selector valve” 12 is turned to reactor 1 of the reactor manifold, so that the line 30 is now connected to reactor 1.

Now the third substance (e.g. activated catalyst) stored in the 200 μL sample loop 20 can charged for sampling to reactor 1, which is already at temperature and pressure and contains solvent plus second substance (e.g. activator).

This procedure (step V and step VI) is repeated for each of the eight reactors placed in the reactor manifold for charging each third activated sensitive substance or compound (e.g. catalyst) from the particular vial to the corresponding reactor.

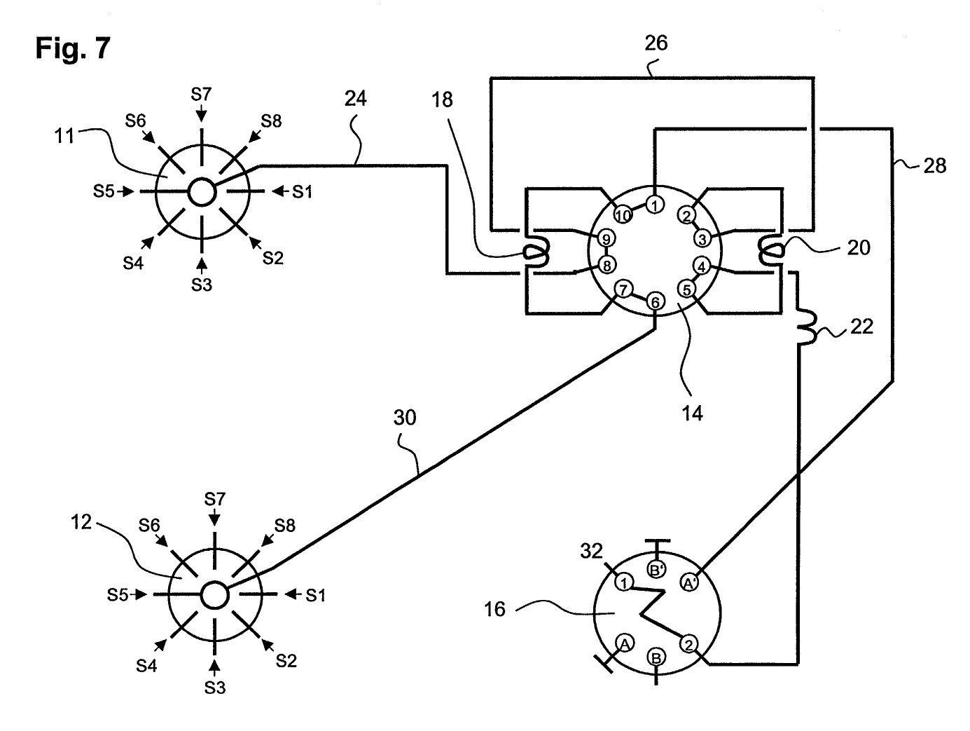

Finally, step VII “Backflush Sample Loop 22 to vial” shown in FIG. 7 is carried out. In this step the “fluid source selector valve” 16 is switched over to Position 2 and the “sample loop selector valve” 14 is switched to Position 1. In addition “vial selector valve” 11 is turned to vial 1 of the vial manifold, so that the line 24 is now connected to vial 1.

The whole contents of the sample loops 22 and 20, and lines 26 and 24 are backflushed with clean solvent to vial 1 containing the sample prior to sampling the next activated substance or compound.

Step VII is also repeated eight times for each vial (1 to 8).

The following Table 1 indicates the valve positions for each valve and primary pump state in each step.

TABLE 1
Valve and Pump Settings Table

| | Vial | Sample Loop | Fluid Source | Reactor | Primary |
|---|---|---|---|---|---|
| Step | Selector | Selector | Selector | Selector | Pump |
| # | Valve 11 | Valve 14 | Valve 16 | Valve 12 | 32 |
| I | 9 (activator) | 2 | 3 | 9 | Off |
| II | 10 (empty) | 1 | 1 | 1 thru 8 | On |
| III | 9 (activator) | 1 | 3 | 9 | Off |
| IV | 1 thru 8 | 1 | 2 | 9 | On |
| V | 1 thru 8 | 1 | 3 | 9 | Off |
| VI | 10 (empty) | 2 | 1 | 1 thru 8 | On |
| VII | 1 thru 8 | 1 | 2 | 9 | On |

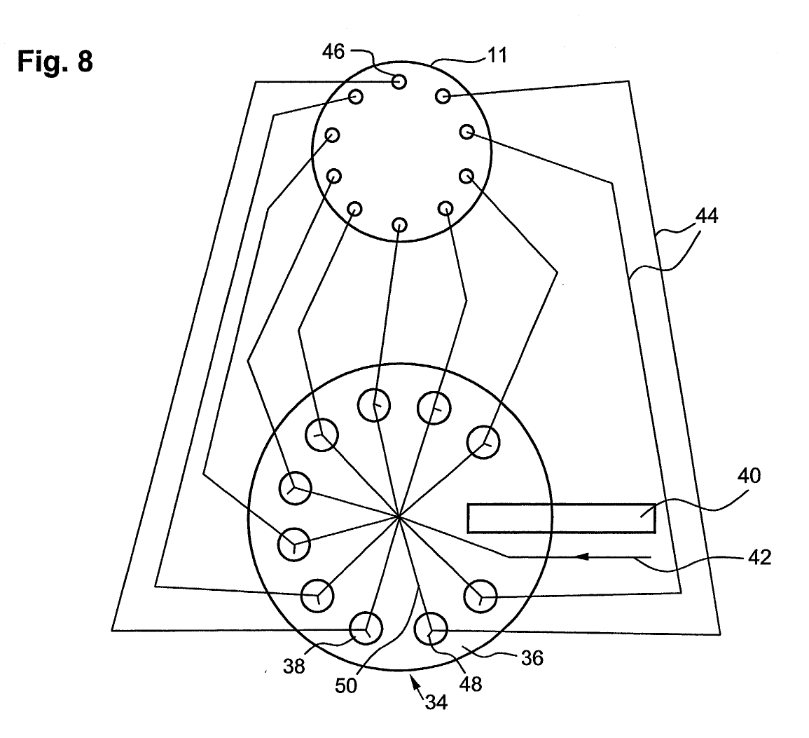

FIG. 8 shows schematically the connections from the “vial selector valve” 11 to the vial manifold 34 for one exemplary embodiment in principle.

In this embodiment the vial manifold 34 comprises an integral block 36 with openings 38, a support rod 40, a common gas supply 42 and lines 44, which connects the particular ports 46 of the “vial selector valve” 11 with the corresponding openings 38 of the vial manifold 34. Also indicated in at the ends of the lines 44 are the single open-ended tubes (dip tubes) 48 for each vial. The vials are not shown in FIG. 8.

The “vial selector valve” 11 can be for example a Rheodyne□ eleven port high pressure valve.

The openings 38 preferred circular provided in the integral block 36 are usually threaded (e.g. 15-425 threads). Additionally each opening 38 provides preferred a seal (not shown in FIG. 8) for at least one O-ring on vial for a fluid-tight connection between vial and integral block 36.

The shape of the integral block 36 as well as the arrangement of the openings 38 in the integral block 36 is not restricted to circular shapes it can be other shaped as well, for example polygonal, oval or any other conceivable shape.

Furthermore, the lines 44 are for example 1/16″ tubes. The manifold 50 preferred for supplying nitrogen could also be other designed, for example, as an external ring with tube connections to each vial, in which the tube connections could be coaxial or separate arranged with the single open-ended tubes 48.

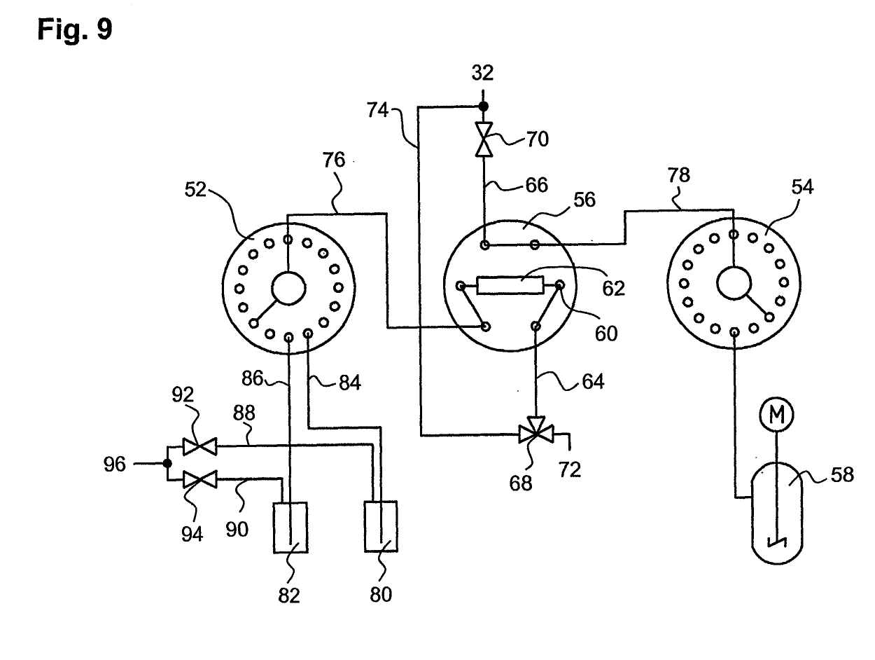

In FIG. 9 is shown an alternative exemplary embodiment for an apparatus arrangement according to the present invention, which needs only three selector valves 52, 54, 56.

In this embodiment two sixteen port selector valves 52 and 54 are provided to handle sixteen vials and reactors respectively. Fifteen vials and reactors respectively for the first sensitive substances or compounds and one vial for supplying the second substance (e.g. activator). Each reactor can be connected over the corresponding port of the selector valve 54 with an autoclave 58.

Additionally a “dosing selector valve” 56 is provided, comprising for example six ports 60 and a storage means 62. The storage means 62, for example, comprises a 200 μL sample loop. Over lines 64 and 66 the “dosing selector valve” 56 is connected to valves 68 and 70. Valve 70 is also connected to a primary pump (solvent pump) 32 and valve 68 is also connected to a syringe pump or other secondary pump (not shown in FIG. 9) over connector 72. Valves 68 and 70 are additionally connected with each other over line 74.

The “sixteen port vial selector valve” 52 and the “sixteen port reactor selector valve” 54 is connected to the “dosing selector valve” 56 over lines 76 and 78.

Ports one to fifteen of the “sixteen port vial selector valve” 52 are each connected over lines 84 with a first substance (e.g. catalyst) reservoir 80 and port sixteen of “sixteen port vial selector valve” 52 is connected over line 86 to a second substance (e.g. activator) reservoir 82. Both, reservoir 80 and reservoir 82 are connected additionally over lines 88 and 90 to valves 92 and 94, which are connected both over connector 96 to a nitrogen source.

List of references:

| | |
|---|---|
| 11 | Svial selector valve |
| 12 | reactor selector valve |
| 14 | sample ioop selector valve |
| 16 | fluid source selector valve |
| 18 | 60 μL sample loop |
| 20 | 200 μL sample loop |
| 22 | 500 μL sample ioop |
| 24, 26, 28, 30 | lines |
| 32 | primary pump (solvent pump) |
| 34 | vial manifold |
| 36 | integral block |
| 38 | opening |
| 40 | support rod |
| 42 | common gas supply |
| 44 | lines |
| 46 | port |
| 48 | single open-ended tubes (dip tubes) |
| 50 | manifold |
| 52 | sixteen port vial selector valve |
| 54 | sixteen port reactor selector valve |
| 56 | dosing selector valve |
| 58 | autoclave |
| 60 | port |
| 62 | storage means |
| 64, 66 | lines |
| 68, 70 | valves |
| 72 | connector |
| 74, 76, 78 | lines |
| 80 | first substance reservoir |
| 82 | second substance reservoir |
| 84, 86, 88, 90 | lines |
| 92, 94 | valves |
| 96 | connector |

What is claimed is:

1. An apparatus for synthesizing and transferring substances which are air-sensitive and/or moisture-sensitive and/or light-sensitive, comprising:
(a) at least three automatic valves;
(b) at least one primary pump;
(c) at least one manifold comprising at least two means for receiving said substances;
(d) at least one tubing system.

2. An apparatus according to claim 1, wherein said apparatus further comprises at least one sample loop.

3. An apparatus according to claim 1, wherein said manifold further comprises:
(a) at least one integral block with means for receiving said at least two means for receiving substances;
(b) at least one fluid supply system;
(c) means for supporting the manifold.

4. An apparatus according to claim 3, wherein said means for receiving substances are vials.

5. An apparatus according to claim 3, wherein said vials comprise means for agitation.

6. An apparatus according to claim 4, wherein said means for agitation comprise an intrusive or non-intrusive device.

7. A process for synthesizing and transferring substances which are air-sensitive and/or moisture-sensitive and/or light-sensitive, within the apparatus according to claim 1 comprising:
(a) charge at least one third substance from a sample loop to at least one reactor at reaction conditions;
(b) sampling at least one third substance.

8. A process according to claim 7, further comprising:
(a) load at least one first substance to at least one means for receiving substances;
(b) load at least one second substance to at least one sample loop;
(c) charge said at least one second substance to said at least one means for receiving substances;
(d) mixing said at least one first substance with said at least one second substance in said at least one means for receiving substances to receive a third substance.

9. A process according to claim 7, further comprising:
(a) backflush the contents of any or all lines with at least one cleaning solvent.

10. Computer program having program code means for performing the process in accordance with one of the claims 7 to 9 or for controlling and/or regulating the apparatus in accordance with one of the claims 1 to 6.

11. Data carrier comprising the computer program in accordance with claim 10.
